(19) United States
(12) Patent Application Publication
(10) Pub. No.: US 2007/0146315 A1
(43) Pub. Date: Jun. 28, 2007

(54) Key input device and key input method thereof

(76) Inventor: Kenichi Ide, Akishima-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/644,832

(22) Filed: Dec. 26, 2006

(30) Foreign Application Priority Data
Dec. 27, 2005 (JP) 2005-376464

(51) Int. Cl. G09G 5/00

(52) U.S. Cl. 345/156

(57) ABSTRACT

According to one embodiment, a key input device and a key input method thereof are disclosed. A key input device 1 is provided which sets a plurality of meanings by the operation with one input key. There are provided both or one of a guard section Gk after a judgment section Hk for selecting the meaning where the meaning corresponding to the preceding judgment section Hk is output by a setting operation for performing the selection, and a subsequent cancel section Ck where the transition procedure of the judgment sections Hk can be canceled halfway. The setting of undesired information is avoided even if there is caused a delay in the setting operation. The setting operation of the plurality of judgment sections Hk transiting in a time-series manner can be canceled in the middle of the transition.

### CROSS-REFERENCE TO RELATED APPLICATIONS

This application is based upon and claims the benefit of priority from Japanese Patent Application No. 2005-376464, filed Dec. 27, 2005, the entire contents of which are incorporated herein by reference.

### BACKGROUND

1. Field

One embodiment of the invention relates to a key input device which is provided in, for example, an information processing apparatus or audio equipment and by which various kinds of data are input/output and various kinds of settings are performed through an input key, and it also relates to a key input method thereof.

2. Description of the Related Art

In general, an input device in an information processing apparatus employs a configuration in which there is arranged a plurality of input keys, such as a keyboard or a touch panel. However, when making it possible to input complicated instructions or characters of a plurality of kinds (e.g., Japanese, English or numerals), the number of input keys becomes considerable if an input key is provided to each of them, so that one key is configured to have a plurality of input functions. When one key has a plurality of input functions (or corresponding meanings) in this manner, such a key input operation is required as to depress a plurality of keys at the same time. Moreover, in applications to, for example, portable equipment or audio equipment wherein a limited degree of data input and selection/instruction is performed, a configuration may be employed in which various kinds of settings and selections are enabled by input with one key.

In connection with such an input device, for example, a technique has been disclosed in Jpn. Pat. Appln. KOKAI Publication No. 2650409 wherein one character key is switched to different meanings depending on the time for which it is depressed (key input mode). To be specific, when a predetermined set time has passed since the depression of the character key, a plurality of key input modes (a graphic code output, a control code output, a capital letter code output and a small letter code output) is sequentially presented by a display function in a circulating manner. If the depression of the character key is canceled when a desired function is displayed, a mode for this function is selected.

In the technique disclosed in Jpn. Pat. Appln. KOKAI Publication No. 2650409, a plurality of threshold values (lengths of time for retaining a depressed state) is provided for the time of depressing one character key, and depending on which of a plurality of sections divided by the threshold values a point at which the depression of the character key is canceled, that is, at which a finger is let off from the key is included in, a key input mode associated with these sections is selected. In this selection, corresponding key input modes are presented in a circulating manner by the display function along with the transition over the sections divided by these threshold values, and a user is expected to release the depressed character key and make a selection while viewing the presentation. FIGS. 9A and 9B show timing diagrams for conventional key input mode selection.

When the user thus performs an operation of canceling the depression by a visual identification, the user lets the finger off after recognizing the visually identified contents of the presentation, which may cause an erroneous operation, such as the selection of an unintended key input mode, due to operation delay time. To be specific, as shown in FIG. 9B, the recognition of the presentation of the sections is started at a point m, and then a time (ΔR) passes, and at a point n close to the end of that section (n: timing with which an operation is started after the recognition and the determination to cancel the depressed state of the input key), the user starts releasing the character key. Time (ΔA) passes from the point n at which the key release is started to a point p at which the release is detected. When there has been a change from the desired section to a next section during this time (ΔA), this means that the mode for the next section is actually selected. Therefore, as shown in FIG. 9B, a delay is caused in the time of visual identification by the user or a delay is caused between the recognition and the key release operation, such that at the point p where the actual release of the character key for a desired section Hk is detected, a next section Hk+1 has already been entered, and an undesired key input mode is selected. When an erroneous selection is made, it is necessary to perform cancel processing, and then depress the character key again to repeat the operation from the beginning. Moreover, when there are a large number of selections and a desired item is found in the first half but has not been successfully selected, the depressed state has to be maintained until a circuit is made of all the sections halfway. Another thing is that even when it is desired to cancel the selection after a circulating display is started, the mode at that point is selected if the finger is let off from the depressed character key halfway, so that it is necessary to perform cancel processing for the selected mode or other operations for cancellation.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing the schematic configuration of a key input device according to a first embodiment of the present invention;

FIG. 2 is an exemplary timing diagram showing setting timing according to a first key input method in the key input device;

FIG. 3 is an exemplary timing diagram showing setting timing as a specific example of the key input method;

FIG. 4 is an exemplary flowchart for explaining the first key input method by the key input device;

FIG. 5 is an exemplary flowchart for explaining a second key input method by the key input device;

FIG. 6 is an exemplary timing diagram showing setting timing according to the second key input method in the key input device;

FIG. 7 is an exemplary timing diagram showing setting timing according to a third key input method in the key input device;

FIG. 8 is an exemplary flowchart for explaining the third key input method by the key input device; and

FIGS. 9A and 9B are exemplary timing diagrams showing key input mode selecting timing as a conventional example.

### DETAILED DESCRIPTION

Various embodiments according to the invention will be described hereinafter with reference to the accompanying drawings. In general, according to one embodiment of the invention, a key input device and a key input method thereof are disclosed. A key input device is provided which sets a plurality of meanings by the operation with one input key. There are provided both or one of a guard section Gk after a judgment section Hk for selecting the meaning where the meaning corresponding to the preceding judgment section Hk is output by a setting operation for performing the selection, and a subsequent cancel section Ck where the transition procedure of the judgment sections Hk can be canceled halfway. The setting of undesired information is avoided even if there is caused a delay in the setting operation. The setting operation of the plurality of judgment sections Hk transiting in a time-series manner can be canceled in the middle of the transition.

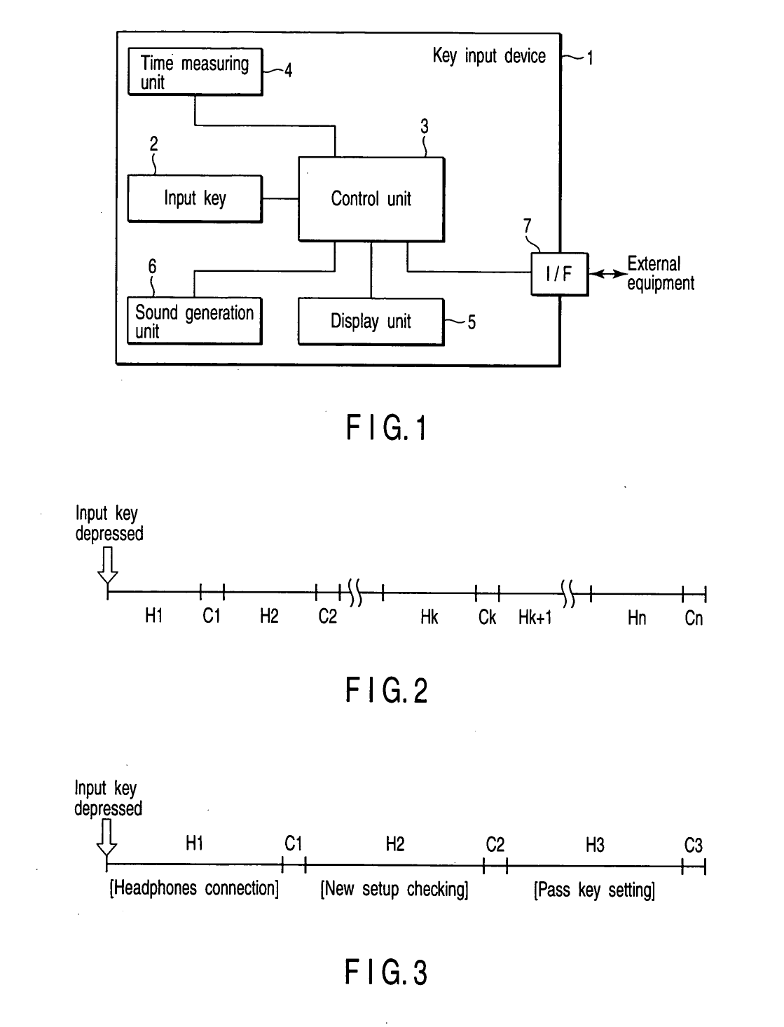

According to an embodiment, FIG. 1 is a diagram showing the schematic configuration of a key input device according to a first embodiment of the present invention.

A key input device 1 comprises one input key 2 for selecting information by switching on/off in a depressing operation, a control unit 3 for outputting input processing based on the setting of each section described later and a selection instruction by the input key 2 to each section and an instruction signal to an external apparatus (e.g., an information processing apparatus); a time measuring unit 4 for measuring passed presentation time and time in which the input key 2 is in an operated (e.g., depressed) state; a display unit 5 for displaying previously input setting information (meaning of the section), input status, etc.; a sound generation unit 6 for informing a user by generating a warning sound for an operational error, a guidance sound such as an input completion sound, or a voice; and an interface (I/F) unit 7 for exchanging signals with an unshown external device.

Furthermore, the control unit 3 has a section presentation setter for set time (i.e., presentation time) in which each section can be selected, and a storage for storing information (such as parameters) on the selection/setting operation with the input key 2 and information on the meaning of processing in each section associated with the switch operation with the input key 2 (key codes or information on a setting operation). It is to be noted that the presentation time of a section may be predetermined fixed time in the configuration to achieve simplification without providing the section presentation setter. The control unit 3 and the time measuring unit 4 may be configured to be included in a processing unit such as a CPU.

The display unit 5 has only to enable the user to understand the meaning of processing, and various display members can be applied thereto, such as a light emitting diode for irradiating a plurality of lights or lights of different colors, a character display unit for indicating the meaning of processing as a shape, or a small liquid crystal display unit for displaying with simple characters, numerals and the like. Moreover, as a form of the display unit, a display unit of the external device can be used for presentation so that the input processing is achieved.

The following description concerns a form wherein one or a combination of the outputs from the display unit 5 and the sound generation unit 6 is used to notify the user of an operation state, input information and the like, and display output and voice/sound output are called presentations, and moreover, the display unit 5 and the sound generation unit 6 constitute a presentation unit. The presentation may be formed by a suitable combination of the display and sound; for example, a buzzer sounds while light presenting the meaning of processing is being emitted, or a sound is generated when the input key 2 is depressed. It is to be noted that this presentation includes not only such visual sensation and auditory sensation but also tactual sensation for concave/convex characters such as Braille or picture writing and olfactory sensation such as smelling. Moreover, the input key 2 is not limited to the switch-on/-off performed by the depressing operation with a mechanical switch, and it is also possible to apply various switches, such as a touch panel switch which is switched on/off by touching, and an optical switch using infrared light in which switch-on/off is achieved by light shielding.

Next, a first key input method by the key input device 1 in the first embodiment will be described.

The present embodiment concerns an operation method wherein the presentations indicating the meaning of a plurality of preset processes (e.g., key codes and various setting items) are arranged in a time-series manner as sections (judgment sections) based on arbitrary time, and a cancel section is placed between the judgment sections, such that the meaning is selectively obtained by an input key operation (depression cancellation).

FIG. 2 is a timing diagram showing timing for setting with the key operation in the key input device 1. In this timing diagram, a point indicated by an arrow shows a start point of depressing the input key. A cancel section Ck (k: 1 to n) is set to be placed between judgment sections Hk (k: 1 to n) by the control unit 3.

The judgment section Hk and the cancel section Ck in the present embodiment will first be described.

Here, to make it easier to understand the meaning of processing presented by the judgment section, there will be described, as a specific example, an audio transmission system using Bluetooth (registered trademark) for setting wireless headphones in a manner communicatable with the audio system, as shown in FIG. 3. Initial setting inputs (e.g., headphones connection, new setup checking and pass key setting) will be explained by way of examples which are performed when headphones equipped with the key input device 1 are used in the audio system.

This timing diagram is started when the user depresses the input key 2, as previously described. Further, the audio system performs the processing corresponding to the judgment section in which the user has canceled the depressed state of the input key 2 (i.e., the user has released the input key 2).

In this example, the judgment sections Hk include, for example, a judgment section H1 (headphones connection), a judgment section H2 (new setup checking), and a judgment section H3 (pass key setting). The cancel section Ck is provided to lie between the judgment sections Hk. Thus, in this example, after sequential transition of H1-C1-H2-C2-H3-C3, there comes an end. Then, a return is made from C3 to H1, and if a stop is not made at any point, a circuit can be made of the sections in accordance with the set time described later. If the display unit 5 is a light emitting diode, the meanings of these three judgment sections H1 to H3 are presented by the colors of emitted lights, and a selectable judgment section is, for example, lighted on/off or flashed. It is to be noted that in the case of the liquid crystal display unit or the like, letters, characters and the like in all the judgment sections may be displayed, and the display of the selectable judgment section may be inverted or enlarged, for example.

In the display unit 5, the emitted light presenting the judgment section H1 is turned off in the cancel section C1 (C2 and C3 also). Then, if the transition is made to the next judgment section H2 (Hk+1), light is emitted to present the judgment section H2. The time for the cancel section C is preferably time which can be recognized by the user, for example, about one second. Thus, the user can distinguish the judgment section H from the cancel section C.

As an example of the meaning of the judgment sections Hk, there will be described the judgment section H1 (headphones connection), the judgment section H2 (new setup checking), and the judgment section H3 (pass key setting) in Bluetooth in FIG. 3. The headphones connection in the judgment section H1 means selecting whether or not to electrically connect wireless headphones which have already been set up to a receiving end of the audio system. That is, when the user has released the input key 2 in the judgment section H1, connection processing for the wireless headphones set up is started.

Furthermore, the new setup checking in the judgment section H2 means selecting whether or not to newly set up the connected wireless headphones (unset). That is, when the user has released the input key 2 in the judgment section H2, the setup processing for the unset wireless headphones is started.

The pass key setting in the judgment section H3 means setting (or changing) a necessary pass key when the Bluetooth is set up. It is to be noted that the pass key signifies a common data row to be set in the devices for connecting by use of the Bluetooth. That is, when the user has released the input key 2 in the judgment section H3, the pass key setting processing is started.

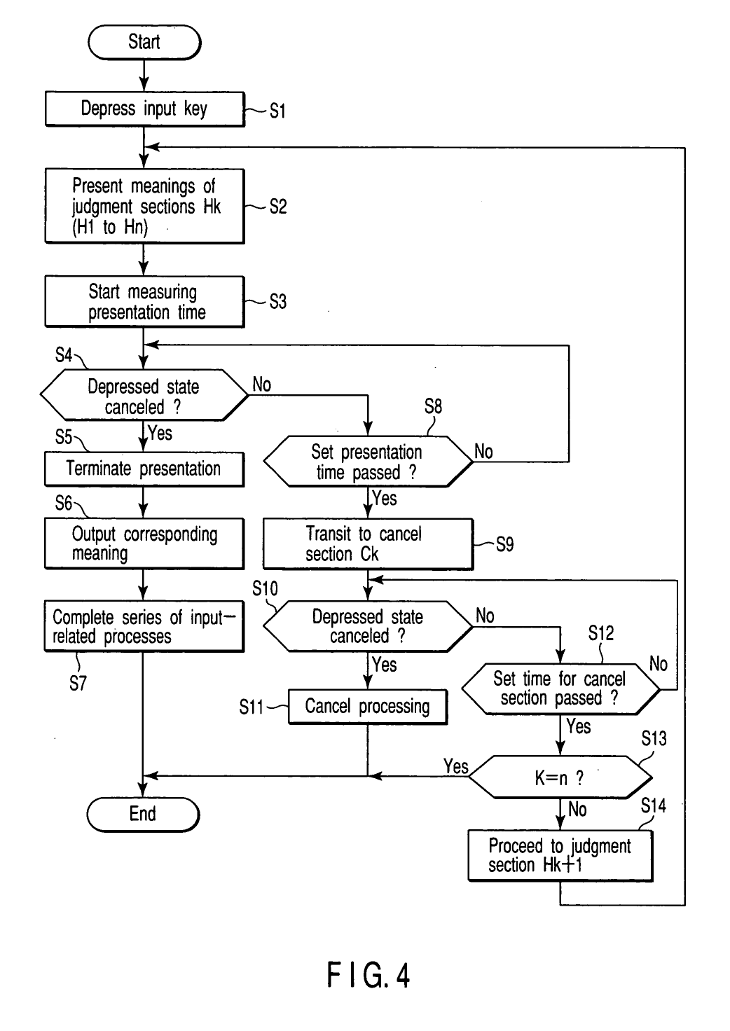

Next, the first key input method by the key input device 1 will be described referring to a flowchart shown in FIG. 4.

The user electrically connects a device equipped with the key input device 1 to an unshown information processing apparatus, whereby initial setting can be performed for the apparatus and device. Next, the user depresses the input key 2 of the key input device 1 (action S1). In connection with this depression of the input key 2, light of a color indicating the meaning of the processing in the judgment section Hk (k=1) is emitted and displayed in the display unit 5 (action S2). Time measurement is started from the time when the light emission/display is presented (action S3).

Next, it is judged whether or not the user has released the input key 2 and canceled the depressed state within preset presentation time for the judgment section Hk (action S4). Here, if the user has canceled the depressed state (YES), the light emission presenting the meaning of the processing in the judgment section Hk is terminated (action S5). In the example described above, if the depressed state is canceled in the judgment section H2 (new setup checking), the presentation by the light emission is terminated.

Next, a specific output corresponding to the judgment section Hk is produced (action S6). For example, in the judgment section H2, a detailed new setup screen follows the presentation that the new setup checking has been selected. Further, in a similar manner, a plurality of parameters displayed after the input key 2 is depressed is sequentially displayed inverted, so that the depressed state is canceled to achieve selection and setting. After a series of input-related processes as described above has been completed (action S7), this sequence is terminated.

On the other hand, if the judgment in action S4 is that the depressed state is not canceled (NO), the depressed state is maintained until the preset presentation time for the judgment section Hk passes (action S8). If it has passed (action S8: YES), the transition is made to the cancel section Ck (k=1) (action S9). For the user, the presentation of the judgment section Hk in the display unit 5 is terminated. The set time for the cancel section Ck at this point is about one second after the light is turned off.

Within this set time for the cancel section Ck, it is judged whether or not the depressed state of the input key 2 has been canceled (action S10). If this judgment is that the depressed state of the input key 2 has been canceled (YES), it is judged that there has been a delay in the operation of releasing the input key 2 or that there has been an instruction for discontinuing the setting operation, thus canceling the series of operations for termination (action S11). That is, the cancellation means a condition where no selection is made, and even if the depressed state of the input key 2 is canceled in the cancel section, there is no output from the interface unit 7. In connection with this termination, sings in the judgment sections H1 to Hn in action 2 are once returned to a presented state, and a routine may be completely terminated if a further termination instruction is given, or the routine may be immediately terminated completely without presenting the signs.

Furthermore, if the judgment in action 10 is that the depressed state is not canceled (NO), the depressed state is maintained until the preset presentation time for the judgment section Hk passes (action S12). When it has passed (action S12: YES), the transition is made to action S13.

In this action S13, Hk is judged as to whether k=n (action S13). That is, it is judged whether or not the preceding judgment section Hk is the final judgment section Hn. If this judgment denies k=n (NO), the transition is made to the judgment section Hk+1 (increment) (action S14), and a return is made to action S2. On the other hand, if k=n (YES), that is, if the preceding judgment section is the judgment section Hn, a series of sequence is terminated.

It is to be noted that if this sequence circulates, it can be set so that a return is again made to the initial judgment section H1 when the current judgment section Hk has reached the final judgment section Hn.

According to the first key input method in the first embodiment described above, the cancel section having a recognizable time interval is provided between the judgment sections H so that a plurality of judgment sections H may not continue.

Thus, even if delay time in the key depression cancellation is caused in the operation of the user, the cancel section is selected, so that it is possible to prevent the undesired next judgment section from being set. Further, even if an operation error is made, cancellation is only made, so that resetting can be immediately started. Moreover, even when it is desired to cancel the setting processing halfway after the operation of the input key, it is not necessary to wait until a circuit is made of all the judgment sections presented in the display unit 5, and if the depressed state of the input key is intentionally canceled with the timing of the switch of the judgment sections, it is possible to easily cancel the routine halfway. Therefore, it is possible to prevent the selection of undesired processing considering visual identification time of the user and release operation delay time, and achieve information input which can be prematurely canceled by a simply operation.

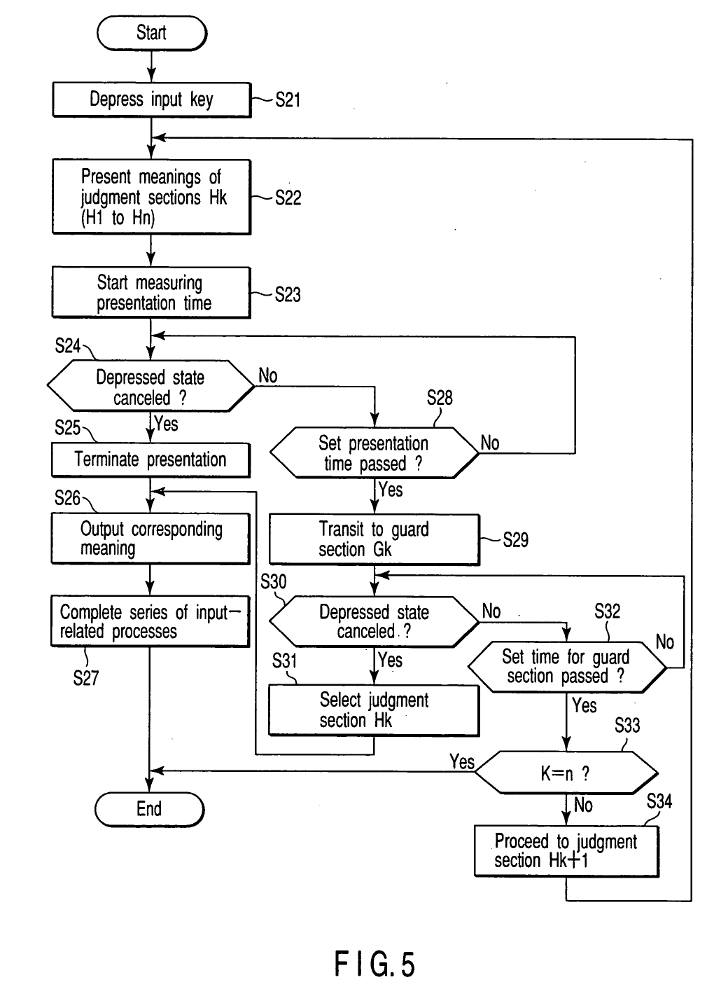

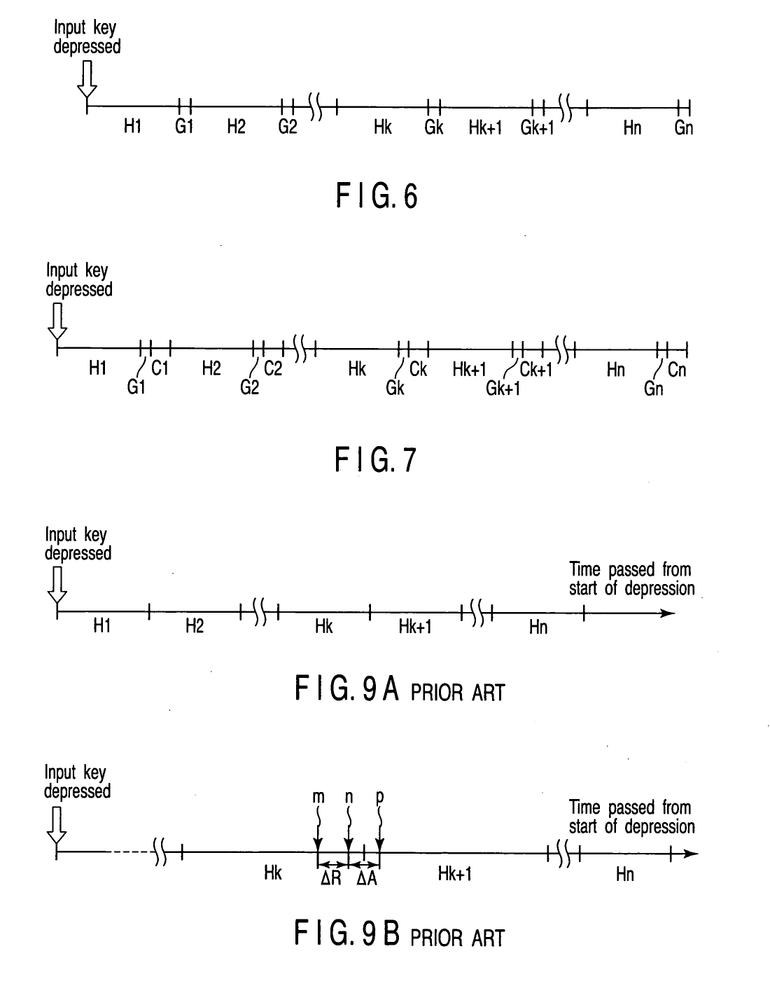

Next, a second key input method by the key input device 1 using the configuration in the first embodiment will be described referring to FIGS. 5 and 6.

In this second key input method, instead of the cancel section descried above, a guard section Gk (k: 1 to n) is set to be placed between the judgment sections Hk (k: 1 to n), as shown in a timing diagram in FIG. 6. In this guard section Gk, the processing corresponding to the preceding judgment section Hk is selected if the depressed state of the input key 2 is canceled within this section. In this guard section G, the presentation in the preceding judgment section H is terminated as in the cancel section C described above.

The time of this guard section G is shorter than that of the cancel section C described above, and may preferably be about 0.5 seconds. This time is experientially set time which only functions during en erroneous setting (delay in the depression cancellation) and which can not be intentionally selected because it is assumed that it takes less than one second for a finger to react after a person has recognized by visual sensation. It is assumed that the time required for the finger to react to auditory sensation is less, but about 0.5 seconds is enough again. If the depressed state is not canceled by the input key 2 within this guard section Gk, the transition is made to the following judgment section Hk+1.

Next, the second key input method by the key input device 1 will be described referring to a flowchart shown in FIG. 5. Explanation will be simplified for action S21 to S27 and action S33 to S34 because these actions in the second key input method are the same as action S1 to S7 and action S13 to S14 in the first key input method described above.

The input key 2 is depressed by the user. In connection with this depression, the processing corresponding to the relevant judgment section H is presented. In connection with the cancellation of the depressed state, an output corresponding to the selected judgment section Hk is performed, and after the series of input-related processes has been completed, the sequence is terminated (action S21 to S27).

If the judgment in action S24 is that the depressed state of the input key 2 is not canceled (NO) and the preset presentation time for the judgment section Hk has passed (action S28: YES), the transition is made to the guard section Gk (k=1) (action S29). For the user, the presentation of the judgment section Hk in the display unit 5 is terminated. The set time for the guard section Gk is about 0.5 seconds from the termination of the presentation. It is judged whether or not the depressed state of the input key 2 has been canceled within this set time for the guard section Gk (action S30). If this judgment is that the depressed state of the input key 2 has been canceled (YES), it is judged that the user has selected the judgment section Hk but there has been a delay in the operation of releasing the input key 2 (action S31). Then, the transition is made to action S26, and the processing corresponding to the judgment section Hk is output.

On the other hand, if the judgment in action S30 is that the depressed state is not canceled (NO), the depressed state is maintained until the preset set time for the guard section Gk passes (action S32). When it has passed (action S32: YES), the transition is made to action S33.

Next, Hk is judged as to whether k=n (action S33). That is, it is judged whether or not the preceding judgment section Hk is the final judgment section Hn. If this judgment denies k=n (NO), the transition is made to the judgment section Hk+1 (increment) (action S34), and a return is made to action S22. On the other hand, if k=n (YES), that is, if the preceding judgment section is the judgment section Hn, a series of sequence is terminated.

The set time in the guard section described above is advantageously normal time in which the user lets the finger off from the input key after recognizing the presentation of the processing and the turning of a switch is detected from the return of the input key. This set time can be considered as the sum of the recognition delay time and operation delay time of the user. However, the recognition delay time and operation delay time vary depending on individual users, and it is therefore assumed that these times are average times among normal healthy persons.

In general, these set times vary depending on the presentation method, such as a method of sign recognition by visual sensation, a method of sound recognition by auditory sensation, or a method of recognition by tactual sensation with the finger or limbs in, for example, a Braille display unit. Therefore, a suitable value is set in accordance with the processing presentation method used in a system. Moreover, these values tend to be increased, for example, with age, so that this can be considered as an adjustment item dependent on the user of the system.

According to the second key input method in the first embodiment described above, the guard section is provided between the judgment sections H so that a plurality of judgment sections H may not continue. Thus, even if a delay is caused in the depression cancellation in which the user releases the input key, the entrance into the next judgment section is prevented within the guard section in which the depression cancellation time is judged as an operation delay, thereby enabling a desired judgment section to be selected.

The set time for the guard section is about 0.5 seconds in the description of the present embodiment, but it is not limited thereto. The required amount of the set time for the guard section varies depending on the level of proficiency in the depression cancellation. That is, if the user has become skilled in the key depression cancellation to some degree, it can be expected that the user releases the input key earlier after the presentation than when the user was inexperienced. In such a case, it can be assumed that the set time for the guard section which was appropriate when the user was inexperienced seems too long. If an adjustment is made in accordance with the level of proficiency of the user, it is possible to improve the usability for individual users. In contrast, if the user who operates is not normal and healthy or is at an old age and has reduced physical response speed, set time is properly adjusted to be longer to suit such a user, thereby permitting a simple and accurate input even when there is a physical difference among individuals.

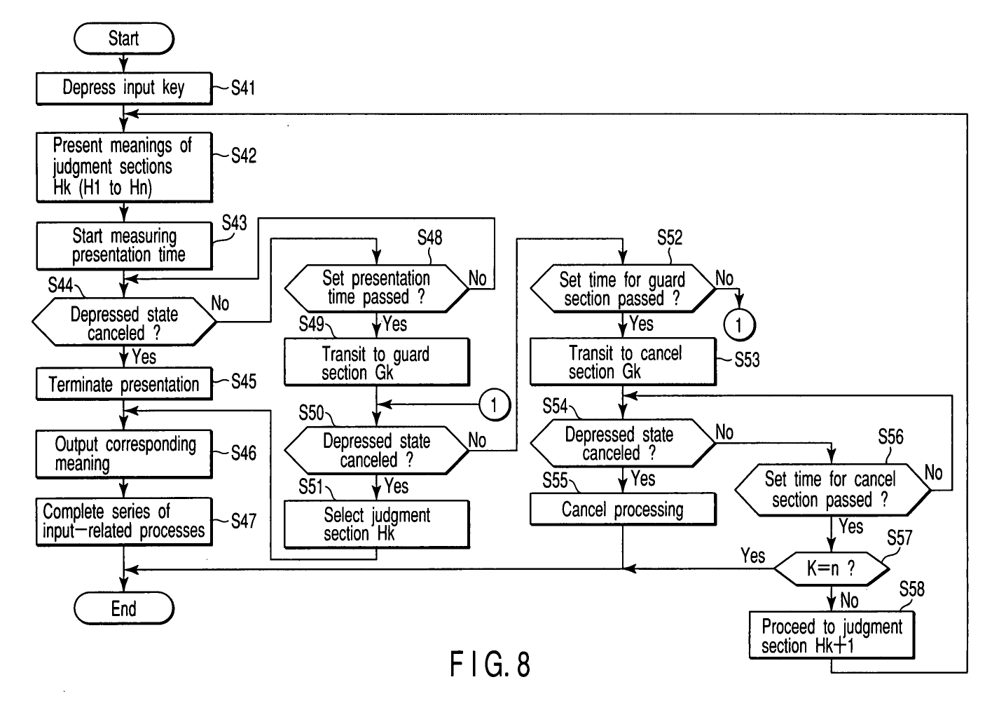

Next, a third key input method by the key input device 1 using the configuration in the first embodiment will be described referring to FIGS. 7 and 8.

In this third key input method, a guard section Gk (k: 1 to n) and a cancel section Ck (k: 1 to n) in the first and second key input methods described above is provided as a pair between the judgment sections Hk (k: 1 to n). The guard section Gk and cancel section Ck have the same functions and effects as those of the sections described above.

As shown in FIG. 7, the guard section Gk and the cancel section Ck are provided in this order after the judgment section Hk. The set times for the guard section Gk and the cancel section Ck are about 0.5 seconds and about one second, in the same manner as described above.

The third key input method by the key input device 1 will be described referring to a flowchart shown in FIG. 8. Explanation will be simplified for action S41 to S47 in this third key input method because these actions are the same as action S1 to S7 in the first key input method described above.

The input key 2 is depressed by the user. In connection with this depression, the meaning (sign) of the processing corresponding to the relevant judgment section H is presented. In connection with the cancellation of the depressed state, an output corresponding to the specific processing corresponding to the selected judgment section Hk is produced, and after the series of input-related processes has been completed, the sequence is terminated (action S41 to S47).

If the judgment in action S44 is that the depressed state of the input key 2 is not canceled (NO) and the preset presentation time for the judgment section Hk has passed (action S48: YES), the transition is made to the guard section Gk (k=1) (action S49). For the user, the presentation of the judgment section Hk in the display unit 5 is terminated. The set time for the guard section Gk is about 0.5 seconds from the termination of the presentation. It is judged whether or not the depressed state of the input key 2 has been canceled within this set time for the guard section Gk (action S50). If this judgment is that the depressed state of the input key 2 has been canceled (YES), it is judged that the user has selected the judgment section Hk but there has been a delay in the operation of releasing the input key 2 (action S51). Then, the transition is made to action S46, and an output corresponding to the specific processing corresponding to the judgment section Hk is produced.

Furthermore, if the judgment in action S50 is that the depressed state of the input key 2 is not canceled (NO), the depressed state is maintained until the preset set time for the guard section Gk passes. When it has passed (action S52: YES), the transition is made to the cancel section Ck (k=1) (action S53).

Next, it is judged whether or not the depressed state of the input key 2 has been canceled within the set time for the cancel section Ck (action S54). If this judgment is that the depressed state of the input key 2 has been canceled (YES), it is judged that there has been a delay in the operation of releasing the input key 2 or that there has been an instruction for discontinuing the setting operation, thus canceling the series of operations for termination (action S55). In connection with this termination, the sings in the judgment sections H1 to Hn in action S41 are once returned to the presented state, and the routine may be completely terminated if a further termination instruction is given, or the routine may be immediately terminated.

On the other hand, if the judgment in action S54 is that the depressed state is not canceled (NO), the depressed state is maintained until the preset set time for the cancel section Ck passes (action S56). When it has passed (action S56: YES), the transition is made to the next action S57.

Next, Hk is judged as to whether k=n (action S57). That is, it is judged whether or not the preceding judgment section Hk is the final judgment section Hn. If this judgment denies k=n (NO), the transition is made to the judgment section Hk+1 (increment) (action S58), and a return is made to action S42. On the other hand, if k=n (YES), that is, if the preceding judgment section is the judgment section Hn, a series of sequence is terminated.

As described above, in the third key input method, the guard section Gk is first introduced, such that even if the user delays in canceling the depressed state of the input key, the processing of a desired judgment section can be selected. It has been impossible to cancel the key input setting routine halfway until a circuit is made of all the judgment sections presented in the display unit 5. However, the cancel section Ck is then introduced, such that the key input setting routine can be canceled with the timing of the switch of the judgment sections, thereby improving the convenience for the user.

As described above, in the key input device and the key input method of the present invention, the guard period having the set time separated from the visual identification time and substantially equal to the operation delay time is provided to follow the judgment section. When an instruction for turning the switch in response to the release of the depressed input key, that is, the cancellation of the depressed state is detected within the guard section in which the presentation of the judgment section is terminated, the processing corresponding to the judgment section immediately before the guard section is selected and output. Thus, undesired processing can be avoided even if there is caused a delay in the switch turning instruction. Furthermore, the cancel section is provided after the guard section, such that the transition procedure for the judgment sections can be canceled halfway. Therefore, the outputs of a plurality of meanings can be obtained in accordance with the depressed state of one input key, and an erroneous selection due to the instruction delay can be avoided. Moreover, a cancellation can be made at every termination of the judgment section without transiting over all of a plurality of the judgment sections, such that the user can cancel the setting operation halfway without waiting to the end, thereby improving the operability.

In the present invention, the guard section is provided between the sections as described above, more specifically, between the adjacent sections. The presentation of the current state to the user is not performed in the guard section, and when the key release is detected within the guard section, a key output corresponding to the section immediately before the guard section is produced. The length of the guard section is separated from the visual identification time of the user and set to be substantially equal to the operation delay time, thereby making it possible to effectively avoid an unintended key output.

Furthermore, the cancellation-permitted section is further provided in addition to the guard section such that the section transition procedure can be canceled halfway. As a result, in the method wherein key outputs for performing a plurality of processes are obtained in accordance with the depression time of one key, the frequency of erroneous operations decreases, and the key depression can be canceled without waiting for the preset sections to be transited over to the end, thereby improving the operability of the user.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A key input device comprising:
one input key;
a time measuring unit which measures time passed after the start of an operation with the input key;
a control unit which sets judgment sections allotted to one or a plurality of processes and an operation section provided to follow each of the judgment sections and which performs processing in accordance with the time passed from the start of the operation with the input key to the end of the operation; and
a presentation unit which presents in a time-series manner the processing performed in the control unit in response to the termination of the operation with the input key when the passed time measured in the time measuring unit is within the judgment section,
wherein after the presentation of the judgment section by the presentation unit has been terminated, the control unit performs the processing in accordance with an operation set in the operation section when the operation with the input key is terminated within the operation section.

2. The key input device according to claim 1, wherein
the operation section is set in a guard section; and
after the presentation of the judgment section by the presentation unit has been terminated, the control unit performs the processing performed in the preceding judgment section when the operation with the input key is terminated within the guard section.

3. The key input device according to claim 1, wherein
the operation section is set in a cancel section; and
after the presentation of the judgment section by the presentation unit has been terminated, the control unit does not perform the processing when the operation with the input key is terminated within the cancel section.

4. The key input device according to claim 2, wherein
the control unit sets a cancel section provided to follow each of the guard sections; and
after the presentation of the judgment section by the presentation unit has been terminated, the control unit does not perform the processing when the operation with the input key is terminated within the cancel section.

5. A key input device comprising:
a presentation unit which presents the meaning of information to select and set a plurality of pieces of information;
one input key to perform the operation of selecting and setting the information on the basis of the presentation by the presentation unit;
a time measuring unit which measures the presentation time and a point of operating the input key;
a storage unit which prestores the plurality of pieces of information and information on the selecting and setting operation with the input key;
a section presentation setting unit which sets the presentation time serving as a time in which the meaning of the information is selectable; and
a control unit which sets a plurality of judgment sections where the selection of the meaning of the information in the presentation time is judged and an operation section provided to follow each of the circularly set judgment sections by the selecting and setting operation, the control unit instructing the external to output input processing based on the selection and setting with the input key.

6. The key input device according to claim 5, wherein
the control unit sets, as the operation section, a guard section where the meaning of the information in the preceding judgment section is selected; and
when the operation of selecting and setting a sign of the meaning of the information presented by the presentation unit is started by the input key in a desired judgment section on the basis of the sign of the above meaning of the information, the control unit further selects the sign of the meaning in the desired judgment section in the case where the selecting and setting operation is terminated within the following guard section.

7. The key input device according to claim 5, wherein
the control unit sets, as the operation section, a cancel section where the selecting and setting operation is canceled; and
the control unit further discontinues the selection and setting when the operation with the input key is terminated within the cancel section.

8. The key input device according to claim 6, wherein
the control unit sets a plurality of judgment sections where the selection of the meaning of the information in the presentation time is judged, and a cancel section which is provided to follow each of the circularly set judgment sections and which is provided to follow each of the guard sections where the selecting and setting operation is canceled in accordance with this operation; and
when the operation of selecting and setting a sign of the meaning presented by the presentation unit is started by the input key in a desired judgment section on the basis of the sign of the above meaning, the sign of the meaning of the information in the desired judgment section is selected and output in the case where the selecting and setting operation is terminated within the following guard section, whereas the selection and setting are discontinued in the case where the operation with the input key is terminated within the cancel section.

9. A key input method of selecting a desired process from a plurality of processes in accordance with a point where an operation of one input key is terminated, the method comprising:
dividing into a plurality of judgment sections for the respective processes, and providing a no-presentation operation section following each of the judgment sections; and
presenting in a time-series manner the process for each of the judgment sections, and outputting a key code associated with the process for the judgment section when a point of operating the input key is within the judgment section, while outputting a key code in accordance with an operation set in the operation section when an end point of the operation is within the operation section.

10. The key input method according to claim 9, wherein
the operation section is set in a guard section; and
the process is presented in a time-series manner for each of the judgment sections, and a key code associated with the process for the judgment section is output when a point of operating the input key is within the judgment section, while a key code in the preceding judgment section is output when an end point of the operation is within the guard section.

11. The key input method according to claim 9, wherein
the operation section is set in a cancel section; and
the process is presented in a time-series manner for each of the judgment sections, and a key code associated with the process for the judgment section is output when an end point of the operation of the input key is within the judgment section, while no key code is output when the end point of the operation is within the cancel section.

12. The key input method according to claim 10, wherein
a no-presentation cancel section is provided to follow each of the guard sections; and
no key code is output when the end point of the operation of the input key is within the cancel section.

13. The key input method according to claim 9 which is a key input method of selecting and obtaining the meanings of a plurality of pieces of information in accordance with time in which a depressed state of one input key is maintained, wherein
the operation section is set in a guard section;
dividing into a plurality of judgment sections for the respective processes, and providing a no-presentation operation section following each of the judgment sections; and
the guard section is provided to divide the time where the depressed state is maintained into a plurality of judgment sections for the respective meanings of the information and to follow each of the judgment sections; and
the information corresponding to the plurality of judgment sections is sequentially presented, and the presentation is terminated when the guard section is reached, and then a key code associated with the information in the judgment section is output when a point of canceling the depressed state of the input key is within the judgment section, while the key code associated with the meaning of the judgment section is output when the point of canceling the depressed state is within the guard section immediately after the judgment section.

14. The key input method according to claim 9 which is a key input method of selecting and obtaining the meanings of a plurality of pieces of information in accordance with time in which a depressed state of one input key is maintained, wherein
the operation section is set in a cancel section;
the cancel section is provided to divide the time where the depressed state is maintained into a plurality of judgment sections for the respective meanings of the information and to follow each of the judgment sections; and
the meanings of the corresponding information are sequentially presented so that the plurality of judgment sections circulate, and the presentation is terminated when the cancel section is reached, and then the meaning of the information associated with the meaning of the judgment section is output when a point of canceling the depressed state of the input key is within the judgment section, while the selection and setting are discontinued when the point of canceling the depressed state is within the cancel section immediately after the judgment section.

15. The key input method according to claim 12, wherein
the time where the depressed state is maintained is divided into a plurality of judgment sections for the respective meanings of the information, and a guard section following each of the judgment sections is provided, and a cancel section following the guard section is further provided; and
the meanings of the corresponding information are sequentially presented so that the plurality of judgment sections circulate, and the presentation is terminated in the guard section and the cancel section, and then the meaning of the information associated with the meaning of the judgment section is output when a point of canceling the depressed state of the input key is within the judgment section, or the meaning of the information associated with the meaning of the judgment section is output when the point of canceling the depressed state is within the guard section immediately after the judgment section, or the selection and setting are discontinued when the point of canceling the depressed state is within the cancel section immediately after the guard section.
